(19) United States
(12) Patent Application Publication
(10) Pub. No.: US 2008/0167002 A1
(43) Pub. Date: Jul. 10, 2008

(54) Method and System for Remote Controlling Operation of Mobile Telecommunication Terminal

(75) Inventors: Jongbae Kim, Seoul (KR); Hoojong Kim, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: SK TELECOM CO., LTD., Seoul (KR)

(21) Appl. No.: 11/910,798

(22) PCT Filed: Aug. 31, 2006
(86) PCT No.: PCT/KR2006/003463

§ 371 Date: Oct. 5, 2007

(30) Foreign Application Priority Data
Aug. 31, 2005 (KR) 10-2005-0080778

(51) Int. Cl. H04M 1/66

(52) U.S. Cl. 455/411

(57) ABSTRACT

Disclosed is a method for remotely controlling an operation of a mobile telecommunication terminal in preparation for a case of loss or theft of the mobile telecommunication terminal, which includes the steps of: (a) monitoring whether a lock setup instruction to enter the lock setup mode is received from the remote control server; (b) controlling a microprocessor included in the mobile telecommunication terminal so as to enter the lock setup mode, when the lock setup instruction is received in step (a); (c) monitoring whether a lock release instruction to enter the lock release mode is received from the remote control server; and (d) controlling the microprocessor so as to enter the lock release mode when the lock release instruction is received in step (c).

### TECHNICAL FIELD

The present invention relates to a method and a system for remote controlling operation of a mobile telecommunication terminal, and more particularly to a method and a system for remotely controlling the operation of a mobile telecommunication terminal in preparation for the case of possible loss or theft of the mobile telecommunication terminal.

### BACKGROUND ART

Information and telecommunication technologies, representatives of which include the Internet and mobile telecommunication, has changed people's life patterns in modern times. It has become possible to acquire information using Web sites, to buy goods through electronic commerce, and to send and receive news through E-mail, by means of Internet-available personal computers in almost all homes, schools, offices, etc. Even just a few years ago, people could use only the mobile telecommunication services mainly for voice communication with their mobile telecommunication terminals. However, even in mobile telecommunication terminals, wireless internet services provided with data communication services using the Internet have recently appeared.

With the appearance of the wireless Internet service, the user can receive not only the voice communication service capable of communicating with a counterpart but also various additional services including a mobile banking service, a content providing service, and an e-government service, regardless of time and space, while the user is moving freely about. Herein, the mobile banking service represents a wireless Internet service for performing financial transaction such as remittance, account transfer, and settlement, by means of a mobile telecommunication terminal. The content providing service represents a wireless Internet service for downloading and reproducing digital content, which includes MP3 files, moving picture files, etc., through a mobile telecommunication terminal. Also, the e-government service represents a wireless communication service which enables the user to be issued with various civil affair documents, such as resident registration (household & individual registration) and an extract of family registration, even without a visit to a “dong” office.

As described above, the wireless Internet services which can be provided by a mobile telecommunication terminal are various, and the performance of the mobile telecommunication terminal has also been developed with a variety of the wireless Internet services. In spite of the fact that the mobile telecommunication terminal is used for very individual use, a means for restricting the operation of the mobile telecommunication terminal is limited to establishment of a password for a mobile telecommunication terminal or the like. When the operation of the mobile telecommunication terminal is restricted only by a password, as in the prior art, the following problems occur.

When the user's mobile telecommunication terminal is lost or stolen and a person, other than the owner, having a malevolent purpose picks up the mobile telecommunication terminal, the person may easily make fraudulent use of various data in the mobile telecommunication terminal by means of a system software, a debugging software, a hacking software, etc. Moreover, if the person having a malevolent purpose makes fraudulent use of an authentication certificate or the like among various data stored in the mobile telecommunication terminal, serious financial loss may occur.

### DISCLOSURE OF THE INVENTION

Therefore, the present invention has been made in view of the above-mentioned problems, and it is an object of the present invention to provide a method and a system for remotely controlling the operation of a mobile telecommunication terminal in preparation for the case of possible loss or theft of the mobile telecommunication terminal.

According to one aspect of the present invention, there is provided a system for remotely controlling an operation of a mobile telecommunication terminal in preparation for a case of possible loss or theft of the mobile telecommunication terminal, the system comprising: a wireless access network which includes a terrestrial infra-structure for transmitting/receiving data to/from the mobile telecommunication terminal wirelessly based on a predetermined protocol, has a handoff function and a radio support/management function, and relays a remote control service for preventing a person, other than an owner of the mobile telecommunication terminal, from accessing the operation of the mobile telecommunication terminal without permission; a mobile communication network which includes communication equipment for providing a voice telecommunication or data exchange service to a plurality of subscribers through a switching center, and relays the remote control service to the mobile telecommunication terminal; and a remote control server which approves access of a wired/wireless terminal requesting the access after user authentication, and provides the remote control service which controls the operation of the mobile telecommunication terminal to enter a lock setup mode or lock release mode.

According to another aspect of the present invention, there is provided a mobile telecommunication terminal provided with a remote control service in cooperation with a remote control server in preparation for a case of loss or theft of the mobile telecommunication terminal in a system which includes: a wireless access network which includes a terrestrial infra-structure for transmitting/receiving data wirelessly based on a predetermined protocol, has a handoff function and a radio support/management function, and relays the remote control service; a mobile communication network which includes communication equipment for providing a voice telecommunication or data exchange service to a plurality of subscribers through a switching center; and the remote control server for approving access of a wired/wireless terminal requesting the access after user authentication, and providing the remote control service, the mobile telecommunication terminal comprising: a key input unit for providing numeric keys for inputting telephone numbers and character keys for inputting characters; a display unit for displaying operational conditions of the mobile telecommunication terminal, including a power utilization state and radio wave reception strength, together with date and time, and displaying a lock setup mode or lock release mode set according to the remote control service; a program storage unit equipped with a terminal control module, which is provided with the remote control service in cooperation with a real time operating system, call processing software for the mobile telecommunication terminal, and the remote control server; and a microprocessor for controlling an entire operation of the mobile telecommunication terminal so that the mobile telecommunication terminal can smoothly perform voice transmission/reception and data transmission/reception, and controlling an operation of the mobile telecommunication terminal according to the terminal control module so as to enter the lock setup mode or the lock release mode.

According to another aspect of the present invention, there is provided a method for remotely controlling an operation of a mobile telecommunication terminal in preparation for a case of loss or theft of the mobile telecommunication terminal in the system, which includes: a wireless access network which includes a terrestrial infra-structure for transmitting/receiving data to/from the mobile telecommunication terminal wirelessly based on a predetermined protocol, has a handoff function and a radio support/management function, and relays a remote control service for preventing a person, other than an owner of the mobile telecommunication terminal, from accessing the operation of the mobile telecommunication terminal without permission; a mobile communication network which includes communication equipment for providing a voice telecommunication or data exchange service to a plurality of subscribers through a switching center, and relays the remote control service to the mobile telecommunication terminal; and a remote control server for approving access of a wired/wireless terminal requesting the access after user authentication, and providing the remote control service which controls the operation of the mobile telecommunication terminal to enter a lock setup mode or lock release mode, the method comprising the steps of: (a) monitoring whether a lock setup instruction to enter the lock setup mode is received from the remote control server; (b) controlling a microprocessor included in the mobile telecommunication terminal so as to enter the lock setup mode, when the lock setup instruction is received in step (a); (c) monitoring whether a lock release instruction to enter the lock release mode is received from the remote control server; and (d) controlling the microprocessor so as to enter the lock release mode when the lock release instruction is received in step (c).

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a view schematically illustrating the construction of a system for remotely controlling the operation of a mobile telecommunication terminal according to an embodiment of the present invention;

FIG. 2 is a block diagram schematically illustrating the construction of a remote control server according to an embodiment of the present invention;

FIG. 3 is a block diagram schematically illustrating the construction of a mobile telecommunication terminal which is provided with the remote control service according to an embodiment of the present invention;

FIG. 4 is a flowchart illustrating a procedure of receiving the remote control service by the terminal control module according to an embodiment of the present invention; and

FIG. 5 is a flowchart illustrating a procedure for controlling an external memory equipped on the mobile telecommunication terminal by the terminal control module according to an embodiment of the present invention.

### BEST MODE FOR CARRYING OUT THE INVENTION

Hereinafter, preferred embodiments of the present invention will be described with reference to the accompanying drawings. In the following description and drawings, the same reference numerals are used to designate the same or similar components, and so repetition of the description on the same or similar components will be omitted.

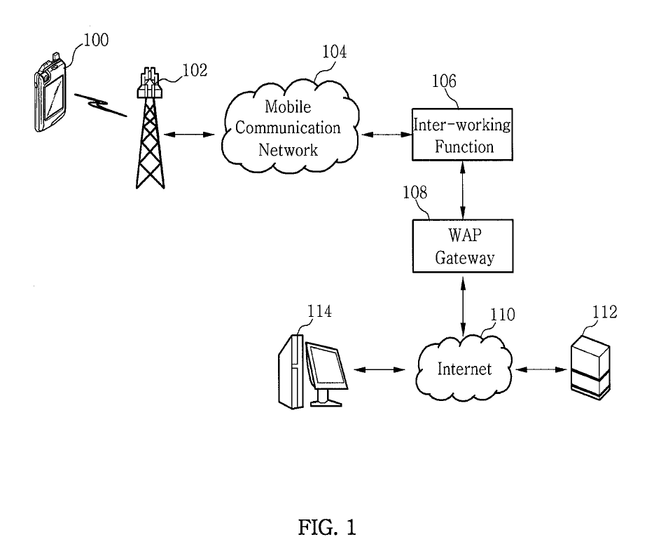

FIG. 1 is a view schematically illustrating the construction of a system for remotely controlling the operation of a mobile telecommunication terminal according to an embodiment of the present invention.

The system for remotely controlling the operation of a mobile telecommunication terminal 100 according to an embodiment of the present invention includes the mobile telecommunication terminal 100, a wireless access network 102, a mobile communication network 104, an inter-working function 106, a WAP gateway 108, the Internet 110, a remote control server 112, and a wired/wireless terminal 114.

In the following description, a “remote control service” is defined as a mobile communication service for allowing the user to access the remote control server 112 by means of the wired/wireless terminal 114 and then to remotely control the operation of the mobile telecommunication terminal 100 through the remote control server 112. According to the principal characteristic of the present invention, when the user accesses the remote control server 112 and requests the control of the operation of the mobile telecommunication terminal 100, the remote control server 112 creates a control instruction, inserts the control instruction into a short message service (SMS) message, and then transmits the SMS message including the control instruction to the mobile telecommunication terminal 100. Then, the mobile telecommunication terminal 100 reads the control instruction included in the SMS message, which has been received from the remote control server 112, and controls the operation of the mobile telecommunication terminal 100 according to the control instruction.

Herein, a “lock setup mode” is defined as a state in which the operation of the mobile telecommunication terminal 100 is controlled to disable an external input including a key input, according to a control instruction received from the remote control server 112. Also, a “lock release mode” is defined as a state in which the mobile telecommunication terminal 100 having entered the lock setup mode receives a control signal from the remote control server 112 and returns to an original state according to the control instruction. In addition, a “lock setup instruction” is defined as a control instruction for instructing the operational state of the mobile telecommunication terminal 100 to enter the lock setup mode, and a “lock SMS message” is defined as an SMS message including the lock setup instruction, from among SMS messages created by the remote control server 112. Also, a “lock release instruction” is defined as a control instruction for instructing the operational state of the mobile telecommunication terminal 100 to enter the lock release mode, and a “release SMS message” is defined as an SMS message including the lock release instruction.

The mobile telecommunication terminal 100 represents a communication terminal which can use a Web service in wired/wireless communication environments. The mobile telecommunication terminal 100 is provided with a remote control service from the remote control server 112, and is equipped with a terminal control module which is software for reading a control instruction included in an SMS message transmitted from the remote control server 112 and controlling the operation of the mobile telecommunication terminal 100. In other words, the mobile telecommunication terminal 100 is connected to the mobile communication network 104 via the wireless access network 102 so as to provide a voice communication function for performing typical voice communication with another mobile telecommunication terminal wirelessly. In addition, when the mobile telecommunication terminal 100 has received a lock SMS message from the remote control server 112, the mobile telecommunication terminal 100 reads a lock setup instruction included in the lock SMS message, and shifts its own operational mode into the lock setup mode that is a state in which an external input including a key input is disabled. Then, when the mobile telecommunication terminal 100 has received a release SMS message from the remote control server 112, the mobile telecommunication terminal 100 reads a lock release instruction included in the release SMS message, and shifts its own operational mode into the lock release mode for returning to the original state from the state in which an external input including a key input is disabled. In addition, when the mobile telecommunication terminal 100 according to the present invention is equipped with an external memory, the external memory also enters the lock setup mode.

The mobile telecommunication terminal 100 cooperates with the remote control server 112 connected to the Internet 110 by accessing the Internet 110 via the mobile communication network 104, by means of an Internet access browser such as a Wireless Application Protocol (WAP) which is an Internet access protocol, Microsoft Internet Explorer (MIE) based on a HyperText Markup Language (HTML) using a HyperText Transfer Protocol (HTTP) protocol, a Handheld Device Transport Protocol, NTT DOCOMO's i-Mode, and SK Telecom's NATE. From among Internet access protocols used in the mobile telecommunication terminal 100, the “MIE” uses m-HTML obtained by slightly modifying and abbreviating the HTML, and the “i-Mode” uses a language called compact HTML (c-HTML) which is a subset of HTML.

The wireless access network 102, which is a network endpoint device connected directly to the mobile telecommunication terminal 100, performs baseband signal processing, wired/wireless conversion, and transmission/reception of radio signals. The wireless access network 102 is disposed in each cell, and transmits a call request of the mobile telecommunication terminal 100, which exists in a cell area managed by the wireless access network 102, to the mobile communication network 104. Also, the wireless access network 102 identifies the location of the mobile telecommunication terminal 100, which exists in a cell area managed by the wireless access network 102, and performs a location information registration.

In addition, the wireless access network 102 relays between the remote control server 112 and the mobile telecommunication terminal 100, and performs radio channel allocation and release for the mobile telecommunication terminal 100, determination of inter-cell soft handoff and hard handoff for the mobile telecommunication terminal 100, transcoding and vocoding, a Global Positioning System (GPS) clock distribution, operation and maintenance of a base station, etc.

The mobile communication network 104, which is a telephone switching network managed by a mobile communication provider, represents communication equipment for providing a voice call or data delivery service to a plurality of non-specific subscribers through a switching center. The mobile communication network 104 provides the mobile telecommunication terminal 100 with a CDMA-2000 service, a WCDBA service, a mobile Internet service, etc. The mobile communication network 104 processes basic and supplementary services, incoming and originating calls of a subscriber, and a location registration procedure and a handoff procedure, performs an interworking function with another network, and processes joining and withdrawal for the remote control service. The mobile communication network 104 of an IS-95 A/B/C system includes subsystems, such as an Interconnection Network Subsystem (INS) for performing a distributed call processing function, a Central Control Subsystem (CCS) for taking charge of a centralization function for operation and preservation, a Location Registration Subsystem (LRS) for performing storage and maintenance functions of information for mobile communication subscribers, etc. In addition, the mobile communication network 104 for the third and fourth generations may include an Asynchronous Transfer Mode (ATM) switch (not shown), which increases the efficiency of transmission speed and line use through cell-by-cell packet transmission.

The inter-working function 106 provides an interface for exchange of data between a wireless communication system and a wired communication system, and functions to convert a protocol, a signal, and data into those of types suitable for each corresponding network. Generally, the inter-working function 106 connects the mobile communication network 104 and the Internet 110.

The WAP gateway 108 corresponds to software and hardware combined with the software, which relays between the mobile telecommunication terminal 100 and the remote control server 112 so that the mobile telecommunication terminal 100 and remote control server 112 can exchange packet data therebetween wirelessly via the mobile communication network 104. The WAP gateway 108 functions to interconnect the mobile communication network 104 and Internet 110 by performing a communication code conversion, a protocol conversion, etc., between the mobile communication network 104 and the Internet 110, in order to quickly retrieve and display information of the Internet 110. That is, the WAP gateway 108 converts a WAP protocol and an Internet Transmission Control Protocol/Internet Protocol (TCP/IP) between them. Therefore, data are transmitted/received between the WAP gateway 108 and the remote control server 112 connected to the Internet 110 by means of the HTTP protocol, and data are transmitted/received between the mobile telecommunication terminal 100 and the WAP gateway 108 by means of the WAP protocol. The WAP gateway 108 converts a website address request based on the WAP protocol from the mobile communication network 104 into an HTTP-based request, and then requests the website address to the remote control server 112 through the Internet 110 according to the HTTP protocol. Also, the WAP gateway 108 converts various contents of the HTML type received from the remote control server 112 into a binary code so that the mobile telecommunication terminal 100 can recognize the contents, and then transmits the contents to the mobile telecommunication terminal 100. Since data having passed through the WAP gateway 108 have been converted into a binary code, the amount of data is reduced, thereby reducing a load upon data transmission to the mobile communication network 104.

As described above, the “WAP” is the general term for communication protocols which enables the user to use the Internet by means of wireless communication terminals, such as the mobile telecommunication terminal 100 or a personal digital assistant. In order to solve the communication speed problem of wireless communication having a relatively slower speed, the WAP converts data into a text code for the Internet 110 and transmits the text code to a wireless communication terminal. Also, since the WAP is designed in consideration of a wireless communication terminal and content which is to use the WAP, the user can use the Internet 110 even with only a wireless communication terminal.

The Internet 110 represents a communication network which provides an access route between the mobile telecommunication terminal 100 and remote control server 112 so that the mobile telecommunication terminal 100 and remote control server 112 can transmit/receive packet data therebetween.

The remote control server 112 corresponds to software and hardware combined with the software, which provide the remote control service for controlling the operation of the mobile telecommunication terminal 100, so as to cause the mobile telecommunication terminal 100 to enter the lock setup mode or lock release mode. When the user's mobile telecommunication terminal 100 becomes lost or stolen, the user accesses the remote control server 112 remotely by means of the wired/wireless terminal 114, and then requests the remote control service. In this case, when the user accesses the remote control server 112 and sets a control instruction for instructing the mobile telecommunication terminal 100 to enter the lock setup mode, the remote control server 112 creates a lock SMS message including a lock setup instruction and transmits the lock SMS message to the mobile telecommunication terminal 100. Thereafter, the mobile telecommunication terminal 100 reads the lock setup instruction included in the lock SMS message received from the remote control server 112, and controls the operation of the mobile telecommunication terminal 100 to enter the lock setup mode. In the lock setup mode, the mobile telecommunication terminal 100 has only a function of receiving a release SMS message including a lock release instruction from the remote control server 112, and maintains a state in which a voice communication service, a data communication service, etc. cannot be used. In addition, the mobile telecommunication terminal 100 maintains a state in which an external input including a key input is disabled, for example, a state in which data cannot be transmitted even if a data cable is connected from the exterior.

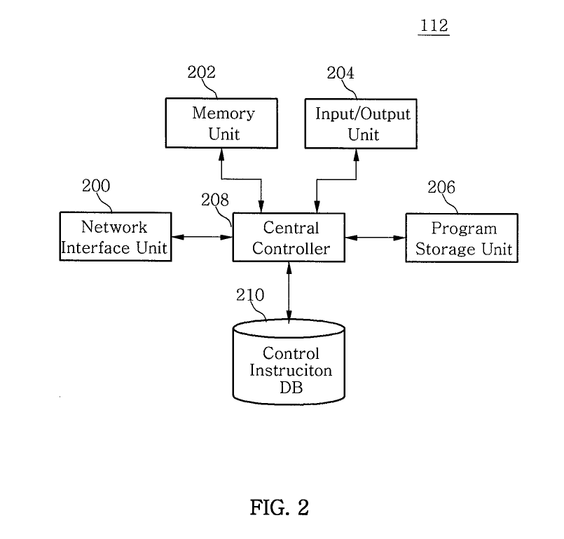

FIG. 2 is a block diagram schematically illustrating the construction of a remote control server according to an embodiment of the present invention.

The remote control server 112 according to an embodiment of the present invention includes a network interface 200, a memory unit 202, an input/output unit 204, a program storage unit 206, a central controller 208, and a control instruction database unit 210.

The remote control server 112 according to the present invention provides a terminal control module, which is software necessary for the mobile telecommunication terminal 100 to receive the remote control service, and creates and transmits a lock SMS message or release SMS message to the mobile telecommunication terminal 100 equipped with the terminal control module so as to cause the mobile telecommunication terminal 100 to enter the lock setup mode or lock release mode. While the above description describes a case in which the remote control server 112 creates an SMS message for a lock setup instruction or lock release instruction to let the operation of the mobile telecommunication terminal 100 enter a lock setup mode or lock release mode, the scope of the present invention is not limited thereto, the present invention may be modified, and various changes may be made therein, such as using a beacon message.

The network interface 200 cooperates with the Internet 110 and the like, and provides a communication interface to the wired/wireless terminal 114 requesting a remote access.

The memory unit 202 temporarily stores data processed by the central controller 208, and temporarily stores data generated during the procedure of providing the remote control service to the mobile telecommunication terminal 100. The input/output unit 204 displays not only a processing state according to a key input but also a processing state for provision of the remote control service.

The program storage unit 206 is equipped with control software which performs:

a task of performing a service joining procedure with respect to the mobile telecommunication terminal 100 which is to be provided with the remote control service, and storing information about the user having completed the joining procedure in the control instruction database unit 210;

a task of creating a user interface in a two-dimensional and/or a three-dimensional graphic shape, which is required for providing the remote control service to the wired/wireless terminal 114, and providing the user interface to an accessing wired/wireless terminal;

a task of providing the wired/wireless terminal 114 requesting access with the remote control service by means of an auto-response service, a web service, etc.;

a task of providing the mobile telecommunication terminal 100 with a terminal control module which is software required for using the remote control service;

a task of creating a lock setup instruction to let the operation of the mobile telecommunication terminal 100 enter the lock setup mode, creating a lock SMS message by inserting the created lock setup instruction into an SMS message, and then transmitting the lock SMS message to the mobile telecommunication terminal 100; and

a task of creating a lock release instruction to let the mobile telecommunication terminal 100, which has entered the lock setup mode, enter the lock release mode, creating a release SMS message by inserting the created lock release instruction into an SMS message, and then transmitting the release SMS message to the mobile telecommunication terminal 100.

The central controller 208 is a kind of central processing unit, and controls a procedure of providing the remote control service from the remote control server 112 to the mobile telecommunication terminal 100. That is, the central controller 208 executes the control software installed in the program storage unit 206, creates a lock SMS message or release SMS message by the executed control software, and transmits the created lock SMS message or release SMS message to the mobile telecommunication terminal 100.

The control instruction database unit 210 stores user information of the user who is to use the remote control service, a terminal control module which is software required for the mobile telecommunication terminal 100 to use the remote control service, a lock setup instruction to let the operation of the mobile telecommunication terminal 100 enter the lock setup mode, a lock release instruction to let the operation of the mobile telecommunication terminal 100 enter the lock release mode, etc.

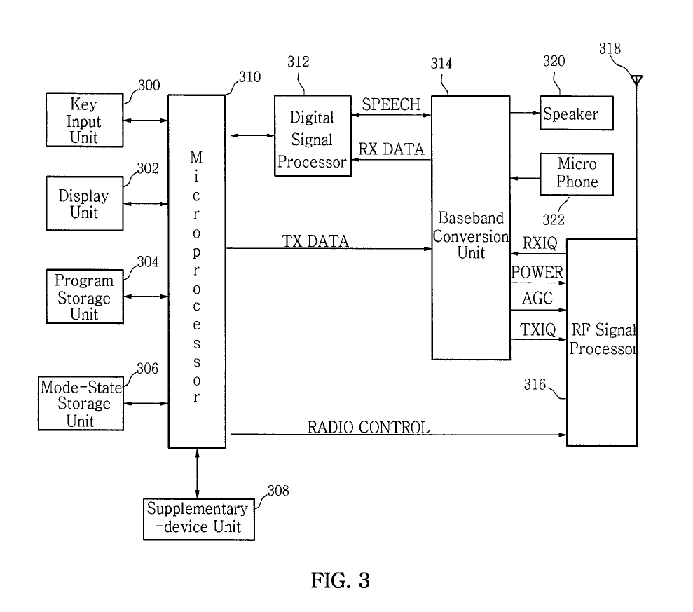

FIG. 3 is a block diagram schematically illustrating the construction of a mobile telecommunication terminal which is provided with the remote control service according to an embodiment of the present invention.

The mobile telecommunication terminal provided with the remote control service according to an embodiment of the present invention includes a key input unit 300, a display unit 302, a program storage unit 304, a mode-state storage unit 306, a supplementary-device unit 308, a microprocessor 310, a digital signal processor 312, a baseband conversion unit 314, an RF signal processor 316, an antenna 318, a speaker 320, a microphone 322, etc.

The following description will be given on the assumption that the mobile telecommunication terminal 100 is equipped with the terminal control module which is required to be provided with the remote control service from the remote control server 112 shown in FIG. 1. In addition, it is assumed that the mobile telecommunication terminal 100 includes an external memory equipped in the supplementary-device unit 308, in which the external memory stores various data requiring security, for example, an authentication certificate, a Digital Rights Management (DRM) document, etc.

The key input unit 300 has numeric keys for inputting numbers (e.g. telephone numbers), character keys for inputting characters, and a specific key for photographing a subject by driving a camera when the mobile telecommunication terminal 100 includes the camera. According to an embodiment of the present invention, when the mobile telecommunication terminal 100 receives a lock SMS message from the remote control server 112, the mobile telecommunication terminal 100 reads a lock instruction included in the lock SMS message and enters the lock setup mode. In the lock setup mode, it is impossible to perform an external input including a key input to the mobile telecommunication terminal 100.

The display unit 302 is equipped on the inside or outside of the mobile telecommunication terminal 100, displays the operational conditions of the mobile telecommunication terminal 100, including a power utilization state and radio wave reception strength, together with date and time. Also, the display unit 302 displays whether the mobile telecommunication terminal 100 is in the lock setup mode or the lock release mode based on a provided remote control service.

The program storage unit 304 includes an Electrically Erasable and Programmable Read Only Memory (EEPROM), a flash memory, a random access memory (RAM), etc. The flesh memory stores a real time operating system, call processing software for the mobile telecommunication terminal, a terminal control module, etc., which are loaded onto the RAM and executed. Herein, the terminal control module represents software which controls:

a function of receiving a lock SMS message transmitted from the remote control server 112 and reading a lock instruction included in the lock SMS message;

a function of controlling the operation of the mobile telecommunication terminal 100 to enter the lock setup mode by using the read lock instruction;

a function of receiving a release SMS message transmitted from the remote control server 112 and reading a release instruction included in the release SMS message;

a function of controlling the operation of the mobile telecommunication terminal 100 to enter the lock release mode by using the read release instruction;

a function of controlling, in the lock setup mode, an external memory also so as to enter the lock setup mode by establishing predetermined authentication information for the external memory when the mobile telecommunication terminal 100 is equipped with the external memory; etc.

Herein, the predetermined authentication information represents authentication information which is established in the remote control server 112 by the user accessing the remote control server 112, and includes numerals, letters, etc. The terminal control module is provided to the mobile telecommunication terminal 100 by being downloaded from the remote control server 112 providing the remote control service or by being installed in the mobile telecommunication terminal 100 by the manufacturer when the mobile telecommunication terminal 100 is manufactured.

Also, the terminal control module may include a plurality of software modules which contain:

a communication channel manager for performing a control operation so as to receive only an SMS message in cooperation with the remote control server 112 and to disable the use of the voice communication service, data communication service, etc;

an event control manager for controlling various events generated during the driving of the terminal control module;

a lock information manager for reading a control instruction included in an SMS message received from the remote control server 112, and controlling the operation of the mobile telecommunication terminal 100 according to the read control instruction;

an external memory manager for controlling an external memory so as to enter the lock setup mode by establishing predetermined authentication information for the external memory when the mobile telecommunication terminal 100 is equipped with the external memory; and

a control manager for controlling the entire operation of the terminal control module.

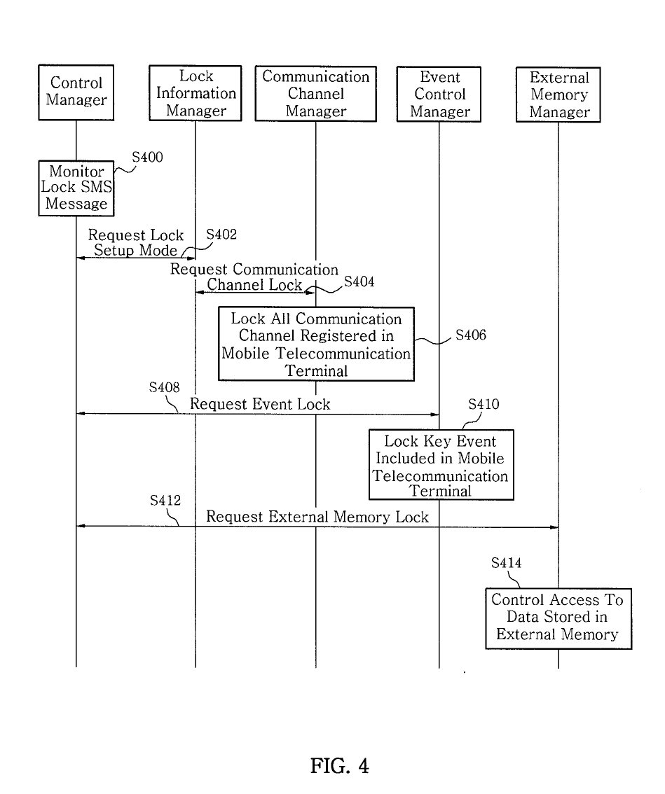

The terminal control module is developed and provided based on the Wireless Internet Platform for Interoperability (WIPI) application. The operation procedure of the terminal control module installed in the mobile telecommunication terminal 100 according to an embodiment of the present invention will be described later in detail with reference to FIGS. 3 and 4.

The mode-state storage unit 306 stores the current operating mode of the mobile communication terminal 100 in accordance with the selection made via the key input unit 300, as a state flag (e.g., 0, 1, 2 . . . ). That is, in order to identify the mobile telecommunication terminal's waiting mode, originating mode, search mode, communication mode, typical incoming mode, lock setup mode and lock release mode according to the remote control service, etc., the microprocessor 310 allocates a specific state flag to each mode and updates the mode-state storage unit 306 according to the current state of the mobile telecommunication terminal 100.

The supplementary-device unit 308 includes an external memory, a camera, etc. which can be equipped in the mobile telecommunication terminal 100.

The microprocessor 310 controls the entire operation in relation to voice transmission/reception and data transmission/reception in the mobile telecommunication terminal 100. Also, the microprocessor 310 controls the operation of the mobile telecommunication terminal 100 to enter the lock setup mode or lock release mode in cooperation with the terminal control module installed in the program storage unit 304, and displays the current state of the mobile telecommunication terminal 100 on the display unit 302.

The digital signal processor 312 acts as an equalizer for coding or decoding voice signals and removing multi-path noise, and performs a sound data processing function. Also, the digital signal processor 312 decodes a lock SMS message or release SMS message transmitted from the remote control server 112. In addition, the digital signal processor 312 transmits/receives voice data (i.e., speech data) to/from the baseband conversion unit 314, and receives digital data “RX DATA” including a lock SMS message or release SMS message from the baseband conversion unit 314.

The baseband conversion unit 314 converts signals, which are transmitted/received among the RF signal processor 316, the digital signal processor 312, the speaker 320, and the microphone 322, into baseband signals, while performing digital to analog conversion and analog to digital conversion. The baseband conversion unit 314 transmits transmission data “TXIQ” to the RF signal processor 316, and controls the power of the RF signal processor 316 or automatically controls the gain thereof. In addition, the baseband conversion unit 314 gets a reception signal “RFIQ” from the RF signal processor 316.

The RF signal processor 316 demodulates and amplifies an RF signal received from the antenna 318. In addition, the RF signal processor 316 modulates a transmission signal applied from the baseband conversion unit 314 and emits the modulated signal into a propagation space. The speaker 320 outputs an audible sound based on sound data transmitted from the baseband conversion unit 314, and the microphone 322 converts a voice input by the user into an electric signal.

Meanwhile, the mobile telecommunication terminal 100 according to an embodiment of the present invention includes a personal digital assistant (PDA), a cellular phone, a personal communication service (PCS) phone, a Global System for Mobile (GSM) phone, a wideband CDMA (W-CDMA) phone, a CDMA-2000 phone, and a mobile broadband system (MBS) phone. Herein, the MBS phone represents a mobile terminal which is to be used in the fourth generation system being currently discussed.

FIG. 4 is a flowchart illustrating a procedure of receiving the remote control service by the terminal control module according to an embodiment of the present invention.

The control manager of the terminal control module installed in the mobile telecommunication terminal 100 monitors whether or not a lock SMS message is transmitted from the remote control server 112 (step 400). When the user's mobile telecommunication terminal 100 is lost or stolen, the user accesses the remote control server 112 by means of the wired/wireless terminal 114 and requests the provision of the remote control service. When the remote control server 112 receives the remote control service provision request, the remote control server 112 creates and transmits a lock SMS message including a lock setup instruction to the mobile telecommunication terminal 100. Then, the control manager of the terminal control module receives the lock SMS message and reads the lock setup instruction included in the lock SMS message, and then requests the lock information manager that the operational state of the mobile telecommunication terminal 100 is controlled to enter the lock setup mode (step 402).

When the lock information manager receives the request for the entering into the lock setup mode, the lock information manager requests the communication channel manager that communication channels required for the use of voice communication service and data communication service, etc. are controlled according to the lock setup instruction (step 404). Then, the communication channel manager controls that all communication channels registered in the mobile telecommunication terminal 100 enter a lock setup mode (step 406).

Thereafter, the control manager requests the event control manager to set an event lock by transmitting the lock setup instruction to the event control manager (step 408). Then, the event control manager controls the operation of the key input unit 300 included in the mobile telecommunication terminal 100 so as to maintain the mobile telecommunication terminal 100 in a state in which an external input including as a key input is disabled, until the event control manager receives a lock release instruction from the control manager (step 410).

After step 410, the control manager requests the external memory manager to let the external memory enter the lock setup mode (step 412). Then, the external memory manager controls the supplementary-device unit 308 of the mobile telecommunication terminal 100 so as to establish predetermined authentication information for the equipped external memory and to let the external memory also enter the lock setup mode (step 414).

Thereafter, when the mobile telecommunication terminal 100 receives a release SMS message including a lock release instruction from the remote control server 112 while being in the lock setup mode, a procedure similar to the above-mentioned procedure is performed to release the lock mode. That is, the control manager controls the communication channel manager to enter the communication channels into the lock release mode, controls the event control manager to enter the key input unit 300 into the lock release mode, and controls the external memory manager to enter the external memory equipped in the mobile telecommunication terminal 100 into the lock release mode.

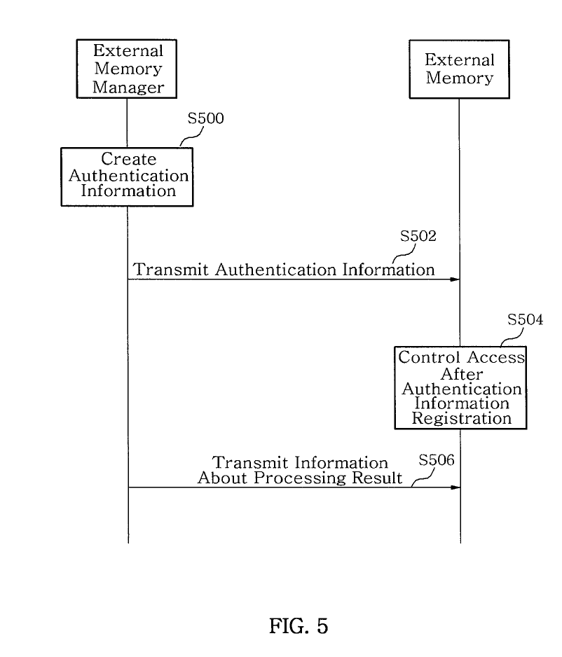

FIG. 5 is a flowchart illustrating a procedure for controlling an external memory equipped on the mobile telecommunication terminal by the terminal control module according to an embodiment of the present invention.

When the external memory manager has received a request for the lock setup mode from the control manager of the terminal control module, the external memory manager creates predetermined authentication information according a lock setup instruction (step 500). The external memory manager transmits the created predetermined authentication information to the external memory via the supplementary-device unit 308 of the mobile telecommunication terminal 100 (step 502).

When the external memory has received the predetermined authentication information from the external memory manager, the external memory registers the authentication information therein and enters the lock setup mode in which the predetermined authentication information must be input in order to access various data stored in the external memory. Thereafter, the external memory notifies the external memory manager that the registration of the authentication information is successfully finished (step 506).

### INDUSTRIAL APPLICABILITY

As can be seen from the foregoing, according to the present invention, when the user's mobile telecommunication terminal becomes lost through carelessness or is stolen by another person having a malevolent purpose, it is possible to remotely control the operation of the mobile telecommunication terminal so that an external input including a key input is disabled, thereby protecting various data stored in the mobile telecommunication terminal. In addition, according to the present invention, it is possible to prevent another person having a malevolent purpose from making an imitation of the mobile telecommunication terminal, accessing a mobile communication network by the imitation, and using a voice communication service, a data communication service, etc. without authorization.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A system for remotely controlling an operation of a mobile telecommunication terminal in preparation for a case of possible loss or theft of the mobile telecommunication terminal, the system comprising:
a wireless access network which includes a terrestrial infra-structure for transmitting/receiving data to/from the mobile telecommunication terminal wirelessly based on a predetermined protocol, has a handoff function and a radio support/management function, and relays a remote control service for preventing a person, other than an owner of the mobile telecommunication terminal, from accessing the operation of the mobile telecommunication terminal without permission;
a mobile communication network which includes communication equipment for providing a voice telecommunication or data exchange service to a plurality of subscribers through a switching center, and relays the remote control service to the mobile telecommunication terminal; and
a remote control server which approves access of a wired/wireless terminal requesting the access after user authentication, and provides the remote control service which controls the operation of the mobile telecommunication terminal to enter a lock setup mode or lock release mode,
wherein the mobile telecommunication terminal needs to receive a lock setup instruction from the remote control server in order to enter the lock setup mode, and, after the mobile telecommunication terminal enters the lock setup mode, it is impossible to perform an external input including a key input, while the mobile telecommunication terminal maintains a communication function necessary for communication with the remote control server.

2. (canceled)

3. The system as claimed in claim 1, wherein the remote control server provides the mobile telecommunication terminal with a control instruction, which controls the operation of the mobile telecommunication terminal so as to enter the lock setup mode or the lock release mode, by inserting the control instruction into at least one of a beacon signal and a short message service (SMS) message.

4. The system as claimed in claim 1, wherein the remote control server is equipped with control software which performs:
a task of performing a service joining procedure with respect to the mobile telecommunication terminal which is to be provided with the remote control service, and storing information about a user having completed the joining procedure in a database unit included in the remote control server;
a task of creating a user interface in a two-dimensional and/or a three-dimensional graphic shape, which is required for providing the remote control service to the wired/wireless terminal, and providing the user interface to the wired/wireless terminal which accesses the remote control server;
a task of providing the wired/wireless terminal requesting access with the remote control service by means of an auto-response service and/or a web service;
a task of providing the mobile telecommunication terminal with a terminal control module which is a kind of software required for using the remote control service;
a task of creating a lock setup instruction to let the operation of the mobile telecommunication terminal enter the lock setup mode and transmitting the created lock setup instruction to the mobile telecommunication terminal; and
a task of creating a lock release instruction to let the mobile telecommunication terminal, which has entered the lock setup mode, enter the lock release mode, and transmitting the lock release instruction to the mobile telecommunication terminal.

5. A mobile telecommunication terminal provided with a remote control service in cooperation with a remote control server in preparation for a case of loss or theft of the mobile telecommunication terminal in a system which includes: a wireless access network which includes a terrestrial infra-structure for transmitting/receiving data wirelessly based on a predetermined protocol, has a handoff function and a radio support/management function, and relays the remote control service; a mobile communication network which includes communication equipment for providing a voice telecommunication or data exchange service to a plurality of subscribers through a switching center; and the remote control server for approving access of a wired/wireless terminal requesting the access after user authentication, and providing the remote control service, the mobile telecommunication terminal comprising:
a key input unit for providing numeric keys for inputting telephone numbers and character keys for inputting characters;
a display unit for displaying operational conditions of the mobile telecommunication terminal, including a power utilization state and radio wave reception strength, together with date and time, and displaying a lock setup mode or lock release mode set according to the remote control service;
a program storage unit equipped with a terminal control module, which is provided with the remote control service in cooperation with a real time operating system, call processing software for the mobile telecommunication terminal, and the remote control server; and
a microprocessor for controlling an entire operation of the mobile telecommunication terminal so that the mobile telecommunication terminal can smoothly perform voice transmission/reception and data transmission/reception, and controlling an operation of the mobile telecommunication terminal according to the terminal control module so as to enter the lock setup mode or the lock release mode,
wherein the terminal control module includes:
a control function for entering the operation of the mobile telecommunication terminal into the lock setup mode, in which an external input including a key input is disabled and only a function of communicating with the remote control server is maintained, according to a lock setup instruction transmitted from the remote control server;
a control function for entering the operation of the mobile telecommunication terminal into the lock release mode according to a lock release instruction transmitted from the remote control server; and
a control function for entering an external memory into the lock setup mode by establishing predetermined authentication information for the external memory when the mobile telecommunication terminal is equipped with the external memory.

6. (canceled)

7. A method for remotely controlling an operation of a mobile telecommunication terminal in preparation for a case of loss or theft of the mobile telecommunication terminal in the system, which includes: a wireless access network which includes a terrestrial infrastructure for transmitting/receiving data to/from the mobile telecommunication terminal wirelessly based on a predetermined protocol, has a handoff function and a radio support/management function, and relays a remote control service for preventing a person, other than an owner of the mobile telecommunication terminal, from accessing the operation of the mobile telecommunication terminal without permission; a mobile communication network which includes communication equipment for providing a voice telecommunication or data exchange service to a plurality of subscribers through a switching center, and relays the remote control service to the mobile telecommunication terminal; and a remote control server for approving access of a wired/wireless terminal requesting the access after user authentication, and providing the remote control service which controls the operation of the mobile telecommunication terminal to enter a lock setup mode or lock release mode, the method comprising the steps of:
(a) monitoring whether a lock setup instruction to enter the lock setup mode is received from the remote control server;
(b) decoding the lock setup instruction by a terminal control module installed in the mobile telecommunication terminal, when the lock setup instruction is received in step (a);
(c) controlling communication channels of the mobile telecommunication terminal according to the decoded lock setup instruction;
(d) controlling the mobile telecommunication terminal so as to disable an external input including a key input to the mobile telecommunication terminal;
(e) controlling a supplementary-device unit included in the mobile telecommunication terminal to cause an external memory equipped in the mobile telecommunication terminal to enter the lock setup mode;
(f) monitoring whether a lock release instruction to enter the lock release mode is received from the remote control server; and
(g) controlling the microprocessor so as to enter the lock release mode when the lock release instruction is received in step (f),
wherein, in step (c), the mobile telecommunication terminal cuts off a communication channel required for using a voice communication service and a data communication service, and opens a communication channel required for receiving the lock setup instruction or lock release instruction transmitted from the remote control server.

8. The method as claimed in claim 7, further comprising, before step (a), the steps of:
(a1) performing, by the remote control server, user authentication with respect to the wired/wireless terminal requesting an access;
(a2) providing the remote control service to the wired/wireless terminal by means of at least one of an auto-response service and a web service;
(a3) receiving a request to let the mobile telecommunication terminal enter the lock setup mode, from the wired/wireless terminal; and
(a4) creating and transmitting the lock setup instruction to the mobile telecommunication terminal according to the request of step (a3).

9. (canceled)

10. (canceled)

11. The method as claimed in claim 7, wherein step (b4) includes the steps of:
(b5) creating predetermined authentication information including a numeral and/or a character for controlling access to the external memory based on the lock setup instruction; and
(b6) registering the predetermined authentication information in the external memory.

12. The method as claimed in claim 7, wherein step (d) includes the steps of:
(d1) receiving, by the remote control server, a request to let the mobile telecommunication terminal enter the lock release mode from the wired/wireless terminal; and
(d2) creating and transmitting the lock release instruction to the mobile telecommunication terminal according to the request of step (d1).
